(19) United States
(12) Patent Application Publication
(10) Pub. No.: US 2026/0356529 A1
(43) Pub. Date: Nov. 12, 2026

(54) LABEL WRAPPING DEVICE

(71) Applicant: BROTHER KOGYO KABUSHIKI KAISHA, Nagoya (JP)

(72) Inventors: Masashi TANIZAKI, Kuwana (JP); Yoshimi IWAMOTO, Nagoya (JP); Tomohiro WADA, Nagoya (JP); Shota IIJIMA, Nagoya (JP); Ryuichi KANDA, Nagoya (JP); Yuya NAKAMURA, Nagoya (JP)

(21) Appl. No.: 19/436,963

(22) Filed: Dec. 30, 2025

(30) Foreign Application Priority Data
May 12, 2025 (JP) 2025-079766

(51) Int. Cl. B65C 9/30; B65C 3/02; B65C 9/00; B65C 9/18; B65C 9/46

(52) U.S. Cl. CPC B65C 9/30; B65C 3/02; B65C 9/0006; B65C 9/1807; B65C 9/1892; B65C 9/46

(57) ABSTRACT

A label wrapping device includes a compartment to receive a medium including a release material and a label, a winding portion to wind the release material, a peeling portion to peel the label from the release material and to change a convey direction of the release material from a first direction to a second direction, and a wrapping portion and to wrap the label around the bar-shaped member. The winding portion is arranged in a different area from the wrapping portion with respect to the first virtual line extending in the first direction, and is arranged in a same area as the compartment with respect to a third virtual line passing through a rotation center of the rotation member of the wrapping portion. The compartment is arranged in a same area as the wrapping portion with respect to the second virtual line extending in the second direction.

### REFERENCE TO RELATED APPLICATIONS

This application claims priority from Japanese Patent Application No. 2025-079766 filed on May 12, 2025. The entire content of the priority application is incorporated herein by reference.

### Background Art

Conventionally, a label wrapping device is known which affixes a label to a bar-shaped member serving as an adherend for the label, for example, to a cable. The label wrapping device produces the label by printing on a tape that is pulled out from a tape cassette. The tape is cut to form the label in the form of a single sheet by a half-cut cutting blade, with a release material intact. The label wrapping device peels the label from the release material at a peeling portion. The peeled label is conveyed to an insertion path for the cable. When a user inserts the cable into the insertion path, an end of the peeled label sticks to the cable. When the user inserts the cable into a wrapping portion in this state, the label wrapping device wraps the label around the cable, and affixes the label to the cable, by the wrapping portion. The peeled release material is conveyed toward a discharge portion located at an upper end portion of a housing different from that of the wrapping portion, and is discharged outside from the discharge portion.

### SUMMARY

The known label wrapping device is not equipped with a mechanism for winding up the release material, so processing of the release material is tedious. However, if a mechanism for winding up the release material were provided, it may result in the device being larger, or the mechanism may hinder insertion of the cable.

An object of the present disclosure is to provide a label wrapping device that includes a winding portion while reducing the size of the device, and which facilitates the insertion of a bar-shaped member into an insertion opening of a wrapping portion.

According to one aspect of the present disclosure, a label wrapping device having the following characteristics wraps a label around a bar-shaped member. The label wrapping device includes a compartment, a winding portion, a peeling portion, a first guide portion, a second guide portion, and a wrapping portion. A medium roll is installed in the compartment. The medium roll is formed by winding a medium with a release material adhered to the adhesive surface of the label.

The winding portion is configured to rotate about a rotation shaft, and convey and wind the release material of the medium pulled out from the medium roll installed in the compartment while applying tension to the release material. The peeling portion is configured to contact the release material of the medium conveyed from the compartment to the winding portion. The peeling portion is configured to change a convey direction of the release material from a first convey direction to a second convey direction, and peel an end portion of the label from the release material.

The wrapping portion includes a rotation member having an insertion opening and is configured to rotate around and support the bar-shaped member inserted through the insertion opening, and wrap the label around the bar-shaped member. The first guide portion is configured to guide the bar-shaped member toward the label that has been peeled from the release material by the peeling portion. The second guide portion is configured to guide the bar-shaped member, with the label affixed after being guided by the first guide portion and peeled off by the peeling portion, toward the insertion opening.

At least a portion of the peeling portion is arranged in an insertion path of the bar-shaped member defined by the first guide portion and the second guide portion. When projected from a direction along an extension of the rotation shaft, a line passing through the peeling portion and extending in the first convey direction is designated as a first virtual line. A line passing through the peeling portion and extending in the second convey direction is designated as a second virtual line. A line passing through the peeling portion and a rotation center of the rotation member of the wrapping portion is designated as a third virtual line.

The winding portion is arranged in an area different from an area where the wrapping portion is arranged with respect to the first virtual line. Moreover, the winding portion does not intersect the third virtual line, and is arranged in a same area as the compartment is arranged with respect to the third virtual line. The compartment is arranged in a same area as the wrapping portion is arranged with respect to the second virtual line.

In this way, the label wrapping device according to the present aspect includes the winding portion, so the release material from which the label has been removed can be wound up. Further, by defining the positional relationship between the winding portion, and the wrapping portion and the compartment, by the first virtual line, the second virtual line, and the third virtual line, the label wrapping device can be made smaller. The winding portion that winds the release material does not intersect the third virtual line. Therefore, when the bar-shaped member is moved along the first guide portion, the bar-shaped member does not contact the winding portion. Therefore, the label wrapping device can be configured to ensure easy insertion of the bar-shaped member into the insertion opening of the wrapping portion.

In the present aspect, the medium may be installed in a roll form by winding the medium with the label arranged on the outside of the release material. The compartment is arranged in an area sandwiched by the first virtual line and the second virtual line when projected from the direction along an extension of the rotation shaft. According to the above-described configuration, the label wrapping device according to the present aspect is capable of, when pulling out the medium from the medium formed in a roll having the label wrapped on the outside, pulling out and conveying the medium without bending the medium in the direction opposite the direction in which the medium is curled.

In the present aspect, the medium may be installed in a roll from by winding the medium with the label arranged to the inside of the release material. The compartment is arranged in a same area as the wrapping portion, among the areas separated by the first virtual line, when projected from the direction along an extension of the rotation shaft. According to the above-described configuration, the label wrapping device according to the present aspect is capable of pulling out and conveying the medium from the medium formed in a roll having the label wrapped on the inside without bending the medium in the direction opposite the direction in which the medium is curled.

In the present aspect, the winding portion may be arranged in an area different from an area where the compartment is arranged, among areas sandwiched by the first virtual line and the third virtual line, when projected from the direction along an extension of the rotation shaft. With the above-described configuration, the device configuration of the label wrapping device according to the present aspect can be made smaller.

In the present aspect, when projected from the direction along an extension of the rotation shaft, the winding portion may be arranged in one of the areas separated by the second virtual line. The area is different from an area where the compartment is arranged. And, when the winding portion is arranged within an area separated by the third virtual line, and another area located between the first virtual line and the third virtual line does not include the winding portion, the angle α formed by the first virtual line and the third virtual line satisfies a condition: 0°< α < 90°.

In the above-described configuration, the angle at which the first convey direction and the second convey direction intersect at the peeling portion is a peeling angle. It is necessary to secure a predetermined angle for the peeling angle in order to peel the label from the release material. Accordingly, by adopting a configuration in which the first convey direction is inclined to reduce the angle α, for example, without changing the peeling angle, the angle at which the second virtual line and the third virtual line intersect can be increased, thereby expanding the area in which the winding portion can be arranged. Accordingly, with the label wrapping device according to the present aspect, the size of the winding portion can be increased while ensuring ease of insertion of the bar-shaped member.

In the present aspect, the label wrapping device further may include a winding guide that is configured to guide the release material from the peeling portion toward the winding portion. The winding guide includes a first bend portion. The first bend portion is configured to contact the release material and change the convey direction of the release material from the second convey direction to a third convey direction. A portion of the winding guide located upstream of the first bend portion extends in the second convey direction. A portion of the winding guide located downstream of the first bend portion extends in the third convey direction, in the third convey direction, the intersection angle with the first convey direction is smaller than the intersection angle between the first convey direction and the second convey direction.

In this way, by changing the convey direction of the release material downstream from the peeling portion, the label wrapping device can expand the area in which the winding portion is arranged without changing the peeling angle. Accordingly, with the label wrapping device according to the present aspect, the size of the winding portion can be increased while ensuring ease of insertion of the bar-shaped member.

In the present aspect, the winding portion may be a reel. The first bend portion may protrude toward the reel with respect to a fourth virtual line contacting the reel from the peeling portion. With the above-described configuration, whether at the start or end of winding when the winding portion winds the release material, the release material is wound onto the reel via the first bend portion. Therefore, the peeling angle of the release material does not change, so the peeling of the label in the label wrapping device according to the present aspect is stable.

In the present aspect, a roller rotatably held may be arranged at the first bend portion. With the above-described configuration, the convey load at the first bend portion can be reduced by the roller, so the label wrapping device according to the present aspect can reduce the risk of breakage of the release material.

In the present aspect, the label wrapping device further may include a half-cut portion that is configured to cut the label without cutting the release material, and is arranged between the compartment and the peeling portion, when projected from the direction along an extension of the third virtual line. Accordingly, the label wrapping device according to the present aspect can not only wind die-cut labels that have been pre-cut to a predetermined size onto the bar-shaped member, but can also cut labels of indefinite length to a desired length and wind those labels as well.

In the present aspect, the label wrapping device further may include a convey guide that is configured to guide the medium from the compartment toward the peeling portion. The convey guide is arranged with a convey path for the medium positioned downstream of the half-cut portion, and includes a second bend portion. The second bend portion is configured to contact the release material and change the convey direction of the release material. A portion of the convey guide located downstream of the second bend portion extends in the first convey direction.

In the above-described configuration, the convey direction of the release material changes downstream of the half-cut portion. Therefore, in the label wrapping device according to this aspect, it is not necessary to arrange the half-cut portion within the housing in an orientation aligned with the first convey direction. Therefore, interference between the half-cut portion and the wrapping portion can be avoided, allowing the device configuration of the label wrapping device to be made smaller.

In the present aspect, a roller rotatably held may be arranged at the second bend portion. With the above-described configuration, the convey load at the second bend portion can be reduced by the roller, so the label wrapping device according to the present aspect can reduce the risk of breakage of the medium.

In the present aspect, the medium may be included in a cassette case in a roll form by winding each of the label and the adhesive material, and the cassette case may be installed in the compartment. With the above-described configuration, the label wrapping device of this aspect enables the cassette case containing the medium formed in a roll to be installed in the compartment in advance, thus facilitating handling of the medium.

In the present aspect, the medium may be included in a cassette case in a roll form by adhering the label and the adhesive material together, and the cassette case may be installed in the compartment. With the above-described configuration, the label wrapping device of this aspect enables the cassette case containing the medium formed in a roll to be installed in the compartment in advance, thus facilitating handling of the medium.

In the present aspect, a print portion may be arranged between the compartment and the half-cut portion when projected from the direction along an extension of the third virtual line. With the above-described configuration, the label wrapping device according to the present aspect is able to print on the label. Accordingly, the label wrapping device according to the present aspect can wind onto the bar-shaped member not only pre-printed labels but also labels that have been printed with desired content.

In the present aspect, the label wrapping device further may include a full-cut portion that is configured to cut the medium. The full-cut portion is arranged between the print portion and the half-cut portion, when projected from the direction along an extension of the third virtual line. With the above-described configuration, full cutting of the medium can be achieved, so with the label wrapping device according to the present aspect, the medium roll can be replaced easily.

In the present aspect, the peeling portion may be a roller that is rotatably held. With the above-described configuration, the convey load at the peeling portion can be reduced by the roller, so the label wrapping device according to the present aspect can reduce the risk of breakage of the release material.

### BRIEF DESCRIPTION OF DRAWINGS

FIG. 1 is a perspective view of a label wrapping device.

FIG. 2 is a perspective view of the label wrapping device with a main cover open.

FIG. 3 is an enlarged cross-sectional view of an area of a compartment within a double-dashed line in FIG. 2 as viewed from the right.

FIG. 4 is an enlarged cross-sectional view of an area within a double-dashed line in FIG. 2.

FIG. 5 is a diagram showing the structure of a tape.

FIG. 6 is a perspective view of a cutting portion as viewed from the upper left front.

FIG. 7 is a front view of a full-cut cutting blade.

FIG. 8 is an enlarged cross-sectional view of an area within a double-dashed line in FIG. 1, in a state where an opening/closing portion has been removed.

FIG. 9 is an enlarged cross-sectional view of an area within a double-dashed line in FIG. 4.

FIG. 10 is a view illustrating the layout of the device configuration.

FIG. 11 is a view for examining a case in which an outwardly wound roll is arranged in area.

FIG. 12 is a view for examining a case where an inwardly wound roll is arranged in area.

FIG. 13 is a right side view of a convey member according to a modified example.

FIG. 14 is a view of a modified example in which a roller member is provided at a bend portion of a first convey guide.

### DESCRIPTION

An embodiment of a label wrapping device 1 embodying a print device according to the present disclosure will be described with reference to the drawings. The referenced drawings are used to illustrate the technological features that can be adopted by the present disclosure, and illustrated configurations of devices, etc. are not intended to limit the present disclosure, and are simply explanatory examples.

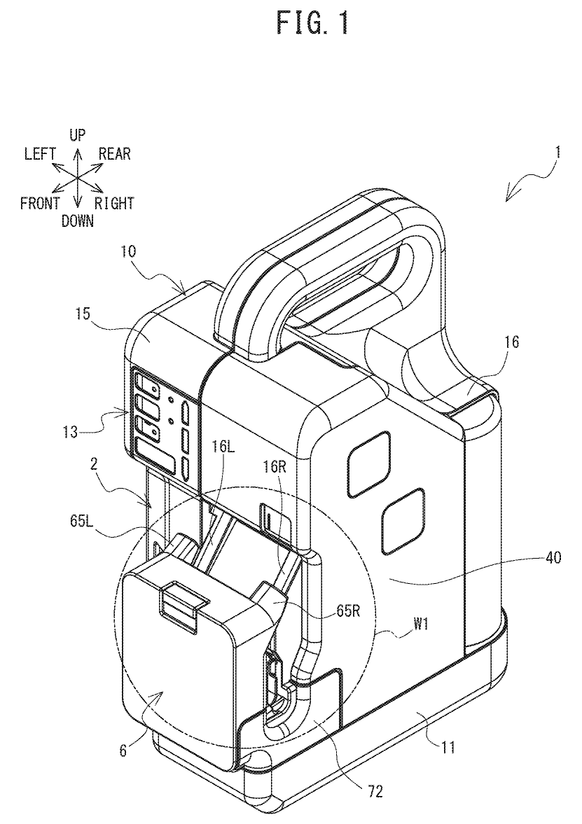

The label wrapping device 1 is a device that produces a label 160 by printing an image onto a tape 150 and affixes the produced label 160 to a cable 19 by wrapping the label 160 around the cable 19. An up-down direction is defined with the direction in which the cable 19 is inserted into a wrapping portion 7 as the downward direction. Moreover, the direction in which a tape cassette 100 is installed into a compartment 30 is defined as a left direction. More specifically, a lower left direction, an upper right direction, an upper left direction, a lower right direction, an upward direction, and a downward direction in FIG. 1 respectively correspond to a front direction, a rear direction, a left direction, a right direction, an upper direction, and a lower direction of the label wrapping device 1.

### Overview of label wrapping device 1

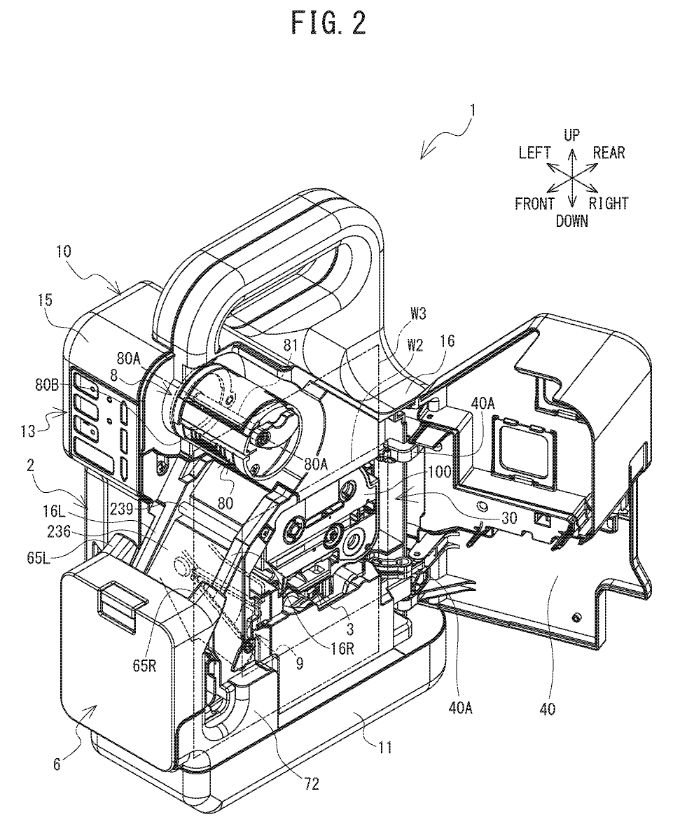

As shown in FIGS. 1 and 2 , the label wrapping device 1 includes a box-shaped housing 10. The housing 10 includes a base 11, a main unit 2, a main plate, a left cover 15, a rear cover 16, a main cover 40, the compartment 30, a print mechanism 3, and a cutting portion 9.

The base 11 serves as the foundation of the label wrapping device 1. The base 11 has a rectangular box shape, and, in a plan view, has a shape in which the left front corner is cut off. The base 11 is located at a lower portion of the housing 10 and supports the housing 10. A power supply board and a battery, etc., are housed within the base 11.

The main unit 2 is a unit that peels off the label 160 from the tape 150 printed by the print mechanism 3 and wraps the label 160 around the cable 19. The main unit 2 includes a peeling portion 4, a presser portion 25, an opening/closing portion 6, and the wrapping portion 7. A lower end of the main unit 2 is fixed to the base 11. The main unit 2 will be described later.

The main plate is a plate-shaped supporting member extending in the up-down direction and the front-rear direction, and is fixed to the housing 10. The main plate is arranged to the left of the center in the left-right direction of the base 11 and extends upward. A lower end of the main plate is fixed to the lower end of the main unit 2 within the base 11. The main plate supports, on a right surface, a drive unit, the compartment 30, the print mechanism 3, and a winding portion 8, and supports, on a front end portion, the cutting portion 9, and supports, on a left surface, a control unit. The control unit controls the operation of the label wrapping device 1. The drive unit drives the print mechanism 3.

The compartment 30 is arranged on the right of the main plate. The print mechanism 3 is arranged below the compartment 30. The cutting portion 9 is arranged in front of the compartment 30. The winding portion 8 is arranged diagonally upward in front of the compartment 30.

The left cover 15 is arranged to the left of the main plate and constitutes the front surface, the rear surface, the top surface, and the left surface of the left portion of the housing 10, which is to the left of the center of the housing 10 in the left-right direction. The left cover 15 covers and protects the control unit arranged on the left surface of the main plate. An input unit 13, which receives inputs from an operation by a user, is arranged at an upper portion of the front surface of the left cover 15.

The rear cover 16 is arranged to the right of the main plate and constitutes the rear surface and the top surface of the right portion of the housing 10, which is to the right of the center of the housing 10 in the left-right direction. The rear cover 16 covers and protects the compartment 30, which is arranged on the right surface of the main plate, from the rear.

The main cover 40 is arranged to the right of the main plate and covers and protects the compartment 30 and the winding portion 8 from the right. At a rear end of the main cover 40, hinges 40A, which are pivotally supported by the front surface of the left end portion of the rear cover 16, are arranged at two positions in the up-down direction. A front end of the main cover 40 swings in the left-right direction with the rear end of the main cover 40 as the axis, thereby opening and closing the compartment 30 and the winding portion 8.

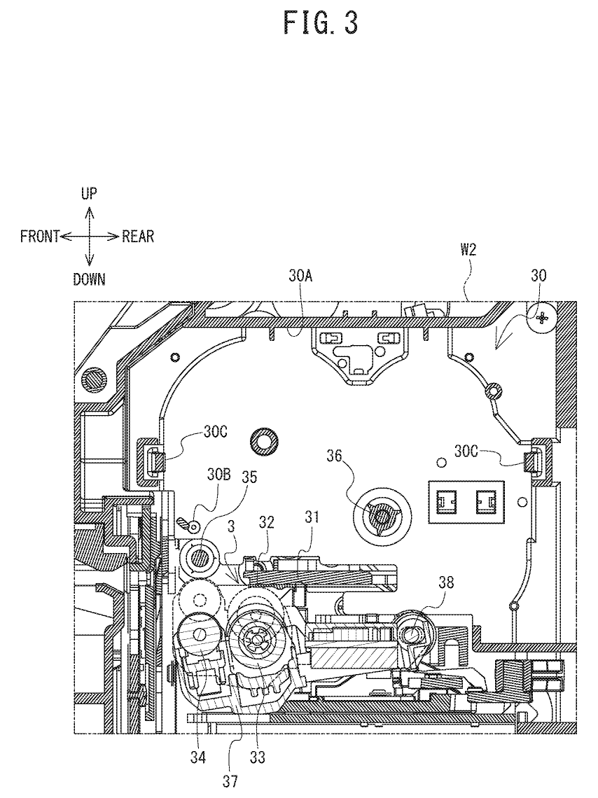

As shown in FIG. 3, the compartment 30 has a box shape that is open to the right, and includes a peripheral wall 30A. The peripheral wall 30A surrounds the tape cassette 100 in the front-rear direction and the up-down direction when the tape cassette 100 is installed. The compartment 30 includes, within the peripheral wall 30A, a positioning portion 30B for positioning the tape cassette 100 and a retaining portion 30C for retaining the tape cassette 100.

The positioning portion 30B is a pin protruding to the right from the front lower corner portion of a bottom surface of a recessed portion of the compartment 30. The positioning portion 30B engages with a positioning hole of the tape cassette 100. The retaining portion 30C is a hook protruding to the right from the front portion and the rear portion of the bottom surface of the recessed portion of the compartment 30. The retaining portion 30C engages with a protrusion formed on a side surface of the tape cassette 100.

Various types of tape cassettes, such as thermal-type tape cassettes, receptor-type tape cassettes, and laminate-type tape cassettes, can be installed in the compartment 30. A thermal-type tape cassette includes a thermal paper tape. A receptor-type tape cassette includes a tape and an ink ribbon.

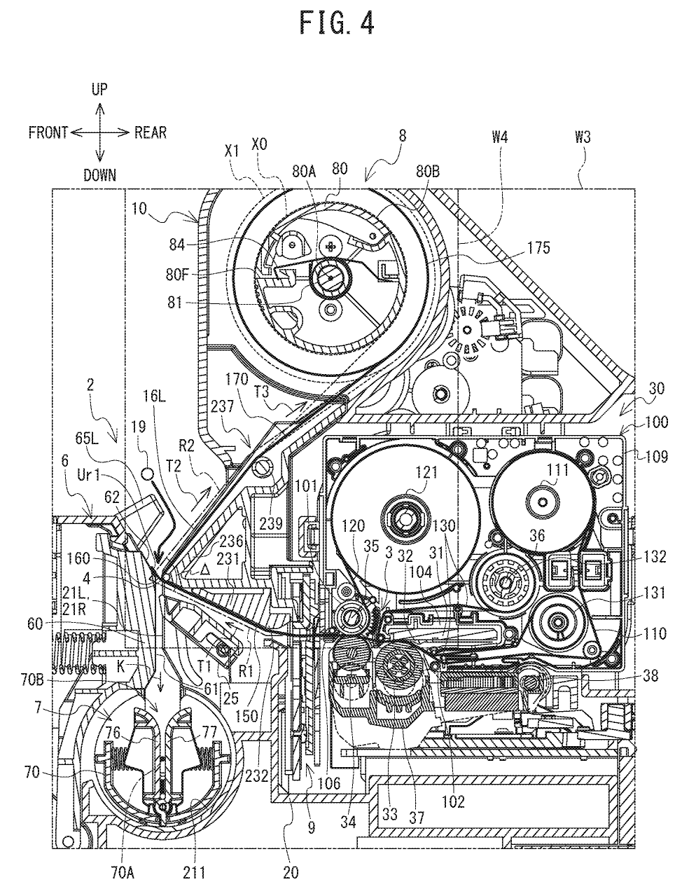

As shown in FIG. 4, the tape cassette used in the label wrapping device 1 of the present embodiment is a laminate-type tape cassette 100. The laminate-type tape cassette 100 includes a film tape 110, a double-sided adhesive tape 120, and an ink ribbon 130. The film tape 110 is a transparent tape made of PET. The double-sided adhesive tape 120 is a tape in which a base material 140 and a release material 170 are laminated via adhesives 141 and 142. The tape cassette 100 will be described later.

### Print mechanism 3

As shown in FIGS. 3 and 4 , the print mechanism 3 is arranged at the lower portion of the compartment 30. Specifically, an opening is provided in the peripheral wall 30A of a lower portion of the compartment 30, and the print mechanism 3 is arranged therein. The print mechanism 3 include a head holder 31, a thermal head 32, a drive shaft 35, a winding shaft 36, a platen roller 33, and a convey roller 34. The head holder 31 is located at the lower portion of the compartment 30. The head holder 31 has a plate shape and extends in both the front-rear direction and the left-right direction.

The thermal head 32 is located on the lower surface of the head holder 31. The thermal head 32 includes a plurality of heating elements. The plurality of heating elements are arranged in a single row in the left-right direction. In a state where the tape cassette 100 is installed in the compartment 30, the thermal head 32 heats the ink ribbon 130 via the plurality of heating elements. When the ink ribbon 130 is heated, the ink is transferred onto the film tape 110.

The head holder 31 not only supports the thermal head 32 but also functions as a heat sink for the heating elements. The drive shaft 35 for conveying the tape 150 is arranged diagonally above and to the front of the head holder 31. The drive shaft 35 extends to the right from the bottom surface of the recessed portion of the compartment 30 and is rotationally driven by a convey motor. When the tape cassette 100 is installed, the drive shaft 35 engages with a shaft hole of the drive roller 101 of the tape cassette 100.

The winding shaft 36 is arranged diagonally above and to the rear of the head holder 31. The winding shaft 36 is rotationally driven by the driving force of the convey motor. When the tape cassette 100 is installed, the winding shaft 36 engages with a winding spool 132 of the tape cassette 100.

A platen holder 37 is arranged below the head holder 31. The platen holder 37 has an arm shape, and has a support shaft 38 extending in the left-right direction on a rear end portion. The platen holder 37 is supported rotatably about the axis of the support shaft 38. The platen roller 33 and the convey roller 34 are rotatably supported at a tip end portion of the platen holder 37. The platen roller 33 comes into and out of contact with the thermal head 32 with the swinging motion of the platen holder 37.

The convey roller 34 is arranged to the left of the platen roller 33. The convey roller 34 comes into and out of contact with the drive roller 101 of the tape cassette 100 with the swinging motion of the platen holder 37. The platen holder 37 swings between a separated position and a printing position in conjunction with the opening and closing of the main cover 40.

When the main cover 40 is opened, the platen holder 37 moves to the separated position. The separated position is a position where the platen roller 33 and the convey roller 34 are separated from the compartment 30. Note that the position of the platen holder 37 shown in FIG. 3 is the separated position. While the platen holder 37 is in the separated position, the user can install the tape cassette 100 into, or remove the tape cassette 100 from, the compartment 30. That is, in conjunction with the opening operation of the main cover 40, the tape 150, which is held pinched at a nip portion between the drive roller 101 and the convey roller 34, is released.

When the main cover 40 is closed, the platen holder 37 moves to the printing position. The printing position is a position where the platen roller 33 and the convey roller 34 are positioned near the compartment 30. Note that the position of the platen holder 37 shown in FIG. 4 is the printing position.

At the printing position, the platen roller 33 presses the film tape 110 and the ink ribbon 130 against the thermal head 32. At the printing position, the convey roller 34 overlays the double-sided adhesive tape 120 with the film tape 110, pinches them at the nip portion, and presses them against the drive roller 101. That is, in conjunction with the closing operation of the main cover 40, the tape 150 is held in a conveyable state by being pinched at the nip portion between the drive roller 101 and the convey roller 34.

The tape cassette 100 houses the film tape 110, the double-sided adhesive tape 120, and the ink ribbon 130 in a box-shaped case 109. Within the tape cassette 100, the film tape 110, the double-sided adhesive tape 120, and the ink ribbon 130 are each wound on their respective corresponding spools 111, 121, and 131.

At the lower portion of the case 109, there is an arm portion 102. The arm portion 102 extends from the rear lower portion to the front lower portion of the case 109. The film tape 110 and the ink ribbon 130 are pulled outside of the case 109 from an opening located at the left end of the arm portion 102, and are overlaid.

A head insertion portion 104 is located above the arm portion 102. The head insertion portion 104 passes through the case 109 in the up-down direction. In a state where the tape cassette 100 is installed in the compartment 30, the head holder 31 is inserted into the head insertion portion 104.

The drive roller 101 is positioned in front of the head insertion portion 104. The drive roller 101 is cylindrical and extends in the left-right direction. The lower end portion of the drive roller 101 is exposed downward from the case 109.

The drive roller 101 supports the double-sided adhesive tape 120 in a state in which the film tape 110 and the double-sided adhesive tape 120 are overlaid with each other. In the state in which the tape cassette 100 is installed in the compartment 30, the drive shaft 35 is inserted into the shaft hole of the drive roller 101. The drive roller 101 rotates by the rotational driving of the drive shaft 35. The drive roller 101 conveys the film tape 110 and the double-sided adhesive tape 120 in a state pinched between the drive roller 101 and the convey roller 34. That is, the tape 150 is conveyed by being fed out from the nip portion formed between the drive roller 101 and the convey roller 34, by the driving of the drive roller 101.

A guide portion 106 is located at a corner portion diagonally downward and at the front of the case 109. The guide portion 106 is located to the left of the drive roller 101. The guide portion 106 is situated downstream of the drive roller 101 in the convey direction of the film tape 110.

The guide portion 106 has a slit shape that extends in the left-right direction. The tape 150, in which the double-sided adhesive tape 120 is affixed to the film tape 110, is conveyed to the drive roller 101 and passes through the guide portion 106. The guide portion 106 supports the tape 150 from both sides in the width direction. The tape 150 is ejected from the tape cassette 100 in a state in which the posture of the tape 150 is maintained by the support of the guide portion 106.

During printing in the print mechanism 3, the platen holder 37 moves from the separated position to the printing position. The platen roller 33 presses the film tape 110 and the ink ribbon 130 in the overlaid state against the thermal head 32. The platen roller 33 rotates and conveys the film tape 110 toward the front.

At the same time the film tape 110 is being conveyed, the thermal head 32 generates heat and the ink ribbon 130 is heated. The ink of the ink ribbon 130 is transferred onto the print surface of the film tape 110 due to the ink ribbon 130 being heated. The print surface of the film tape 110 is the surface that faces the thermal head 32 within the case 109, that is, the surface facing upward. By the transfer of ink, images including characters, for example, are printed on the film tape 110. After printing, the ink ribbon 130 separates from the film tape 110 and is wound onto the winding spool 132.

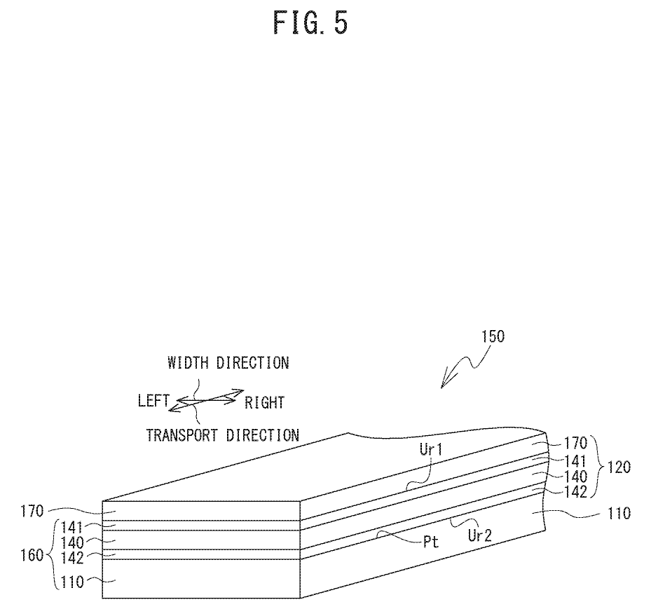

As shown in FIG. 5, the adhesives 141 and 142 are applied on both surfaces of the base material 140 of the double-sided adhesive tape 120. The release material 170 is adhered to an adhesive surface Ur1, to which the adhesive 141 is applied, of the double-sided adhesive tape 120. An adhesive surface Ur2 to which the adhesive 142 is applied, of the double-sided adhesive tape 120, is overlaid onto a print surface Pt of the printed film tape 110. With the film tape 110 arranged below the double-sided adhesive tape 120, the film tape 110 and the double-sided adhesive tape 120 pass between the drive roller 101 and the convey roller 34. By affixing the film tape 110 to the base material 140 with the adhesive 142, the printed label 160 is produced.

The upper surface of the label 160 corresponds to the adhesive surface Ur1 to which the adhesive 141 of the base material 140 is applied, so the release material 170 becomes affixed to the adhesive surface Ur1. That is, the tape 150 is produced in a state in which the release material 170 is affixed to the label 160 by the double-sided adhesive tape 120 being affixed to the film tape 110. The label 160 is of indefinite length and is cut in the form of a single sheet of a predetermined or arbitrary length at the cutting portion 9. The widthwise direction of the tape 150 corresponds to the left-right direction.

### Cutting portion 9

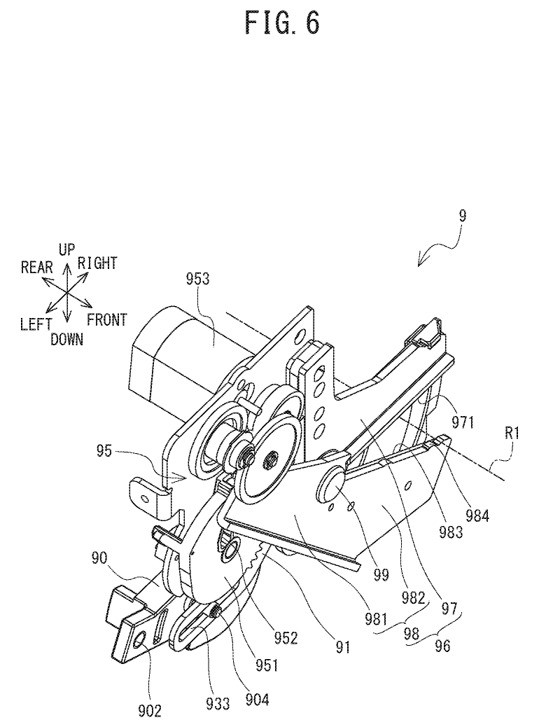

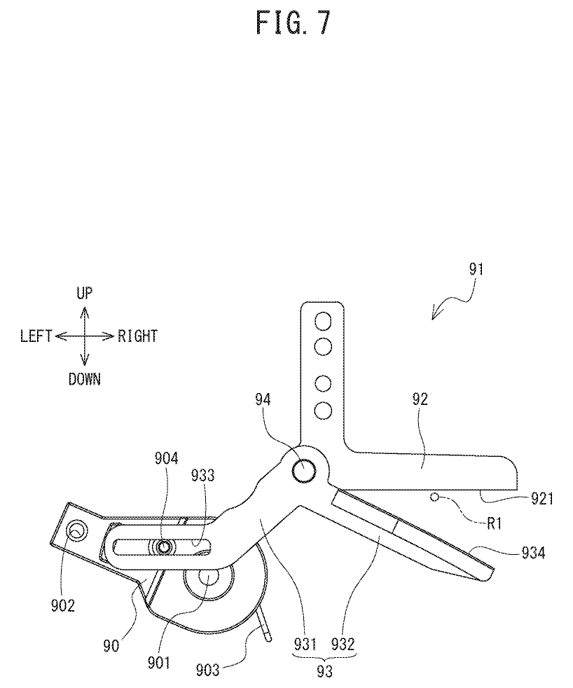

The cutting portion 9 is arranged downstream of the convey roller 34 in the convey direction of the tape 150. As shown in FIGS. 6 and 7 , the cutting portion 9 includes a full-cut cutting blade 91 and a half-cut cutting blade 96. The full-cut cutting blade 91 includes a fixed blade 92, which is fixed above a convey path R1, and a movable blade 93, which is rotatable below the convey path R1. The convey path R1 is a path along which the tape 150 is conveyed from the print mechanism 3, through the cutting portion 9, to the peeling portion 4. The fixed blade 92 extends in the left-right direction, and has a cutting edge 921 facing downward.

The movable blade 93 has a plate shape extending bent, and is rotatably supported by a rotation shaft 94. The rotation shaft 94 is provided to the left of the convey path R1 and extends in the front-rear direction. The movable blade 93 includes a left end portion 931 that extends bent toward the left of the rotation shaft 94, and a right end portion 932 that extends straight toward the right of the rotation shaft 94. The left end portion 931 includes a long hole 933. The right end portion 932 faces toward the right with a cutting edge 934 extending in the left-right direction facing upward.

The cutting portion 9 includes a connecting portion 90 located to the left of the convey path R1 and to the rear of the full-cut cutting blade 91. The connecting portion 90 extends in the left-right direction, with a right end portion thereof being rotatably supported by a rotation shaft 901. The rotation shaft 901 is provided diagonally downward to the left of the rotation shaft 94, and extends in the front-rear direction.

A torsion spring 903 is provided around the rotation shaft 901 on the rear surface of the connecting portion 90. The torsion spring 903 urges the connecting portion 90 in a clockwise direction with the rotation shaft 901 as a fulcrum when viewed from the front. A connecting hole 902 is formed in the left end portion of the connecting portion 90. An interlocking bar engages with the connecting hole 902. A pin 904, which engages with the long hole 933 of the movable blade 93, is provided between the rotation shaft 901 of the connecting portion 90 and the connecting portion 90 itself.

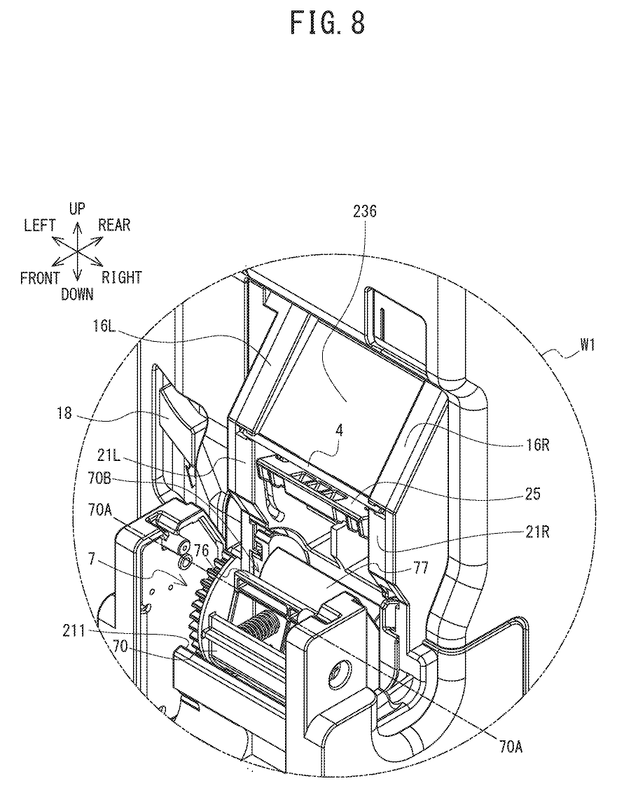

As shown in FIG. 8, an operation lever 18 that slides in the up-down direction when operated by the user is arranged at the lower front portion of the left cover 15 of the housing 10. The operation lever 18 is connected to the full-cut cutting blade 91 via the interlocking bar. In response to the user operation, the full-cut cutting blade 91 moves the cutting edge 934 of the movable blade 93 across the convey path R1 from below the convey path R1 to above the convey path R1 with respect to the cutting edge 921 of the fixed blade 92. The movable blade 93 fully cuts the tape 150 conveyed along the convey path R1. That is, the tape 150 is cut by being pinched between the fixed blade 92 and the movable blade 93.

As shown in FIG. 6, the half-cut cutting blade 96 is arranged downstream, that is, in front, of the full-cut cutting blade 91 in the convey path R1. The half-cut cutting blade 96 includes a fixed base 97 located above the convey path R1, and a movable blade 98 rotatably arranged below the convey path R1. The fixed base 97 extends in the left-right direction and includes a blade contact surface 971 facing downward, i.e., facing the convey path R1. The movable blade 98 has a plate shape, extending left-right direction, and is supported by a rotation shaft 99. The rotation shaft 99 is arranged to the left of the convey path R1 and extends in the front-rear direction.

The movable blade 98 includes a left end portion 981 that extends straight toward the left of the rotation shaft 99, and a right end portion 982 that extends straight toward the right of the rotation shaft 99. The left end portion 981 includes, on an end portion thereof, a pin protruding toward the rear. The right end portion 982 faces upward, thereby orienting a cutting edge 983, which extends in the left-right direction, upward. On an end portion of the right end portion 982, a protrusion 984 is formed that protrudes slightly above the cutting edge 983. The height by which the protrusion 984 protrudes upward above the cutting edge 983 is approximately equal to the thickness of the release material 170.

The cutting portion 9 includes a transmission unit 95 that is positioned to the left of the convey path R1 and to the rear of the half-cut cutting blade 96, and which transmits the driving force of a cutting motor 953 to the movable blade 98. The transmission unit 95 has a plurality of gear sets, and the drive shaft of the cutting motor 953 meshes with the uppermost gear. A lowermost drive gear 951 of the transmission unit 95 includes a long groove 952 with which the pin at the left end portion 981 of the movable blade 98 engages. The long groove 952 extends from near the rotation center of the drive gear 951 toward the outer periphery thereof.

The cutting motor 953 rotates the drive gear 951 and moves the pin within the long groove 952, thereby moving the movable blade 98 between a cutting position and a stand-by position. The cutting position is a position in which the movable blade 98 rotates counterclockwise from the stand-by position in a front view, and the protrusion 984 on the right end portion 982 abuts against the blade contact surface 971 of the fixed base 97. In this case, a gap equal to the thickness of the release material 170 is formed between the cutting edge 983 of the movable blade 98 and the blade contact surface 971. The stand-by position is a position where the movable blade 98 rotates clockwise from the cutting position in a front view, and the cutting edge 983 of the right end portion 982 retracts below the convey path R1.

The half-cut cutting blade 96 is such that a gap equal to the thickness of the release material 170 is formed between the cutting edge 983 and the blade contact surface 971 due to the protrusion 984. The movable blade 98 performs a half-cut of the label 160 on the tape 150 conveyed along the convey path R1. That is, the label 160 of the tape 150 is cut, while the release material 170 remains uncut.

### Main unit 2

As shown in FIG. 4, the main unit 2 includes a base body 20 that supports the entirety of the unit. The base body 20 is made of resin, and both surfaces are reinforced by metal plates. The base body 20 includes the peeling portion 4, the presser portion 25, the opening/closing portion 6, and the wrapping portion 7.

The bottom portion of the base body 20 is fixed at a position toward the front right of the base 11. The wrapping portion 7 for wrapping the label 160 around the cable 19 is arranged in the bottom portion. A semi-cylindrical housing portion 211 is provided in the bottom portion. A rotation body 70 of the wrapping portion 7 is housed within the housing portion 211.

The middle portion of the base body 20 is located above the bottom portion. A peeling region where the label 160 is peeled away is provided in the middle portion. The peeling portion 4, the presser portion 25, and the opening/closing portion 6 are all provided in the peeling region. The upper portion of the base body 20 is located above the middle portion. A first convey guide 231 and a second convey guide 236 are arranged in the upper portion.

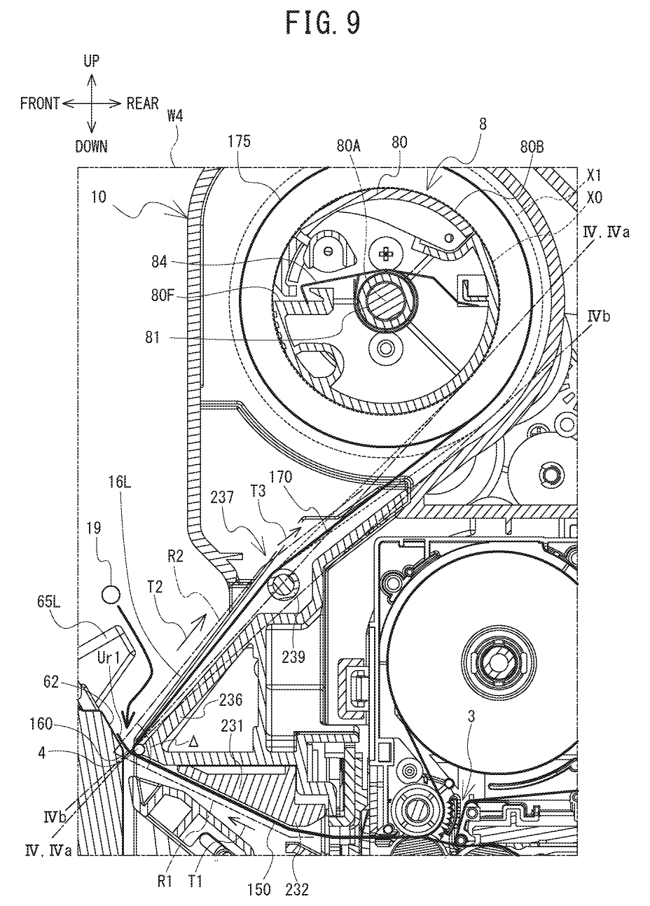

As shown in FIG. 9, the first convey guide 231 extends forward from the position of the cutting portion 9 in a right side view. The first convey guide 231 has a bend portion 232 and extends along a first convey direction T1 from the bend portion 232 towards the peeling portion 4 positioned diagonally upwards towards the front. The first convey direction T1 is the direction of a tangent line that contacts the bend portion 232 and the peeling portion 4. The first convey direction T1 is also the direction from the bend portion 232 toward the peeling portion 4 when the release material 170 of the medium is conveyed while under tension applied by the winding portion 8. The first convey guide 231 guides the tape 150 to the peeling portion 4 along the convey path R1.

The lower end of the second convey guide 236 is arranged from a position connected to an end portion of the first convey guide 231 in the first convey direction T1 to the winding portion 8. The peeling portion 4 is arranged at a lower end portion of the second convey guide 236. The second convey guide 236 has a bend portion 237, and extends from the lower end portion toward the bend portion 237, which is positioned diagonally upward and to the rear in a right side view, along a second convey direction T2. The second convey direction T2 is the direction of a tangent line that contacts the peeling portion 4 and the bend portion 237. The second convey direction T2 is also the direction from the peeling portion 4 toward the bend portion 237 when the release material 170 of the medium is conveyed while under tension applied by the winding portion 8.

The bend portion 237 is arranged at a position above the center in the up-down direction of the second convey guide 236. A portion of the second convey guide 236 downstream of the bend portion 237 extends along a third convey direction T3. The third convey direction T3 is the direction of the tangent line that contacts the bend portion 237 and the winding portion 8. The third convey direction T3 is also the direction from the bend portion 237 toward the winding portion 8 when the release material 170 of the medium is conveyed under tension applied by the winding portion 8.

The direction of the third convey direction T3 changes as the release material 170 is wound onto the winding portion 8. An intersection angle between the first convey direction T1 and the third convey direction T3 is smaller than an intersection angle between the first convey direction T1 and the second convey direction T2. The second convey guide 236 guides the release material 170 from which the label 160 has been peeled at the peeling portion 4, along a convey path R2 to the winding portion 8. The convey path R2 is a path along which the release material 170 is conveyed from the peeling portion 4 to the winding portion 8.

As shown in FIG. 9, the upper surface of the second convey guide 236 is bent into a mountain shape at the bend portion 237. A round bar-shaped roller member 239 extending in the left-right direction is arranged at the bend portion 237. The roller member 239 is arranged rotatably supported by a shaft above the second convey guide 236. The roller member 239 protrudes toward a reel 80 relative to a virtual line IV that connects the peeling portion 4 to the reel 80 of the winding portion 8.

Of the second convey guide 236, the portion above the bend portion 237 extends in the third convey direction T3 diagonally upward and to the rear at a shallower upward angle than the lower portion. The intersection angle between the third convey direction T3 and the first convey direction T1 is smaller than the intersection angle between the first convey direction T1 and the second convey direction T2.

The release material 170 conveyed from the peeling portion 4 to the winding portion 8 comes into contact with the roller member 239 along the convey path R2. The release material roll 175 is a roll of the release material 170 wound onto the winding portion 8, and the outer diameter thereof varies according to the amount wound. The roller member 239 adjusts the convey direction of the release material 170 passing through the roller member 239 in accordance with changes in the outer diameter of the release material roll 175.

In a state X0 at the start of winding of the release material 170, the outer diameter of the release material roll 175 is approximately equal to the outer diameter of the reel 80. Therefore, in the state X0 at the start of winding, the roller member 239 at the bend portion 237 protrudes toward the reel 80 with respect to a virtual line IVa contacting the release material roll 175 from the peeling portion 4. As the release material 170 is wound onto the winding portion 8, the outer diameter of the release material roll 175 increases. In a state X1 at the end of winding of the release material 170, the outer diameter of the release material roll 175 becomes larger than the outer diameter of the reel 80.

The positional relationship between the peeling portion 4 and a rotational axis center 80A of the reel 80 in the state X1 at the end of winding remains constant and unchanged from that in the state X0 at the start of winding. Accordingly, in the state X1 at the end of winding, a virtual line IVb contacting the release material roll 175 from the peeling portion 4, inclines more in the horizontal direction than the virtual line IVa. Therefore, in the state X1 at the end of winding, the roller member 239 at the bend portion 237 protrudes toward the reel 80 with respect to the virtual line IVb contacting the release material roll 175 from the peeling portion 4.

That is, the release material 170 is wound up by the reel 80 via the roller member 239 at the bend portion 237, both in the state X0 at the start of winding of the release material 170 and in the state X1 at the end of winding of the release material 170. Furthermore, the positional relationship between the peeling portion 4 and the roller member 239 is constant. Accordingly, a peeling angle Δ, which is the angle at which the tape 150 is bent when passing through the peeling portion 4, remains constant. The peeling angle Δ is the angle formed between the first convey direction T1, in which the release material 170 is conveyed along the first convey guide 231, and the second convey direction T2, in which it is conveyed along the second convey guide 236.

### Peeling region

The peeling portion 4 is located at a portion where the convey path R1, defined by the first convey guide 231, and the convey path R2, defined by the second convey guide 236, intersect. The peeling portion 4 is a round bar-shaped roller extending in the left-right direction. The peeling portion 4 engages with a recess formed in the lower end portion of the first convey guide 231 and rotates. The surface of the peeling portion 4 has a coating layer that inhibits the adhesion of the adhesive 141 when peeling the label 160 from the release material 170.

The convey path R1 and the convey path R2 are bent at the above-described peeling angle Δ at the peeling portion 4. The peeling portion 4 comes into contact with the release material 170 and changes the convey direction of the release material 170 from the first convey direction T1 to the second convey direction T2. The peeling angle Δ is an acute angle. The peeling portion 4 peels the label 160 while the winding portion 8 applies tension to the release material 170 in the second convey direction T2 and winds the release material 170. The label 160 is peeled off due to force acting in the first convey direction T1 from the rigidity of the label 160, that is, force acting in a direction in which it is peeled from the release material 170.

The control unit controls the convey amount of the tape 150. Because the distance between the peeling portion 4 and the print mechanism 3 is fixed, the control unit conveys the tape 150 after printing so that the end portion of the label 160 reaches the position where it is peeled away by the peeling portion 4. After peeling, the release material 170 moves in the second convey direction T2 toward the winding portion 8, while the end portion of the peeled label 160 is positioned spanning from the peeling portion 4 to a support surface 62 of an upper portion of the opening/closing portion 6. The control unit halts convey when, by controlling the amount of tape 150 conveyed, the end portion of the label 160 reaches a position in which it spans the support surface 62. That is, the end portion of the label 160 is the portion arranged spanning from the peeling portion 4 to the support surface 62 when the convey of the tape 150 is halted so that the label 160 can be affixed to the cable 19.

As shown in FIGS. 2,4, and 8, first guide portions 16L and 16R are respectively arranged to the left and right of the second convey guide 236. The first guide portion 16L is arranged to the left of the second convey guide 236, extends along the second convey direction T2, and includes a surface facing diagonally upward and toward the front. The first guide portion 16R is arranged to the right of the second convey guide 236, extends along the second convey direction T2, and includes a surface facing diagonally upward and toward the front. The first guide portions 16L and 16R respectively protrude diagonally upward to the left from the upper surface of the second convey guide 236.

The first guide portion 16L and 16R guide the cable 19 toward the end portion of the label 160, which has been peeled away from the release material 170 by the peeling portion 4. As shown in FIG. 4, the end portion of the label 160 peeled off by the peeling portion 4 is arranged at a position spanning from the peeling portion 4 to the support surface 62 of the opening/closing portion 6, with the adhesive surface Ur1 exposed. The cable 19 moves while in contact with the upper surface of the first guide portions 16L and 16R, thereby inhibiting the cable 19 from being affixed to the width direction of the label 160 at an angle.

The opening/closing portion 6 has a box shape extending in the up-down direction, and is arranged at the front portion of the base body 20. The upper portion of the opening/closing portion 6 swings in the front-rear direction with a shaft, which extends in the left-right direction at the lower end portion of the opening/closing portion 6 as the fulcrum. The housing portion 211 of the wrapping portion 7 is opened and closed by this swinging of the opening/closing portion 6.

The opening/closing portion 6 includes the support surface 62, protrusions 65L and 65R, and a pressing portion 60. The support surface 62 is arranged at the upper end and the rear end of the opening/closing portion 6. The support surface 62 faces diagonally upward and to the rear. The support surface 62 supports the end portion of the label 160 from below.

The protrusions 65L and 65R are positioned at the upper end portion of the opening/closing portion 6. The protrusion 65L is located at the left end portion of the opening/closing portion 6. The protrusion 65R is located at the right end portion of the opening/closing portion 6. The protrusions 65L and 65R protrude from the upper end portion of the opening/closing portion 6 toward the downstream in the second convey direction T2. The lower surfaces of the protrusions 65L and 65R are opposed to the front end portions of the first guide portions 16L and 16R.

The opening/closing portion 6 includes the pressing portion 60 on a rear surface in the closed state. The pressing portion 60 includes a pressing surface 61 extending in the up-down direction and facing rearward. When the user moves the cable 19 from the peeling portion 4 toward the wrapping portion 7, the user moves the cable 19 while pressing against second guide portions 21L and 21R. The cable 19 passes between the second guide portions 21L and 21R and the pressing surface 61, and is guided downward.

The second guide portion 21L is arranged in the left part of the peeling region, extends in the up-down direction, and includes a surface facing forward. An upper end of the second guide portion 21L is connected to a lower end of the first guide portion 16L. The second guide portion 21R is arranged in the right part of the peeling region, extends in the up-down direction, and includes a surface facing forward. An upper end of the second guide portion 21R is connected to a lower end of the first guide portion 16R. The peeling portion 4 is positioned at the upper end portions of the second guide portions 21L and 21R, and is arranged between the second guide portion 21L and the second guide portion 21R.

As shown in FIG. 4, the user grips the cable 19 extending in the left-right direction with both hands and brings the cable 19 into contact with the first guide portions 16L and 16R. The first guide portions 16L and 16R guide the cable 19 toward the end portion of the label 160, which is exposed with the adhesive surface Ur1 facing upward at the peeling portion 4. At the peeling portion 4, the end portion of the label 160 is affixed to the cable 19.

The second guide portions 21L and 21R guide the cable 19 to which the end portion of the label 160 is affixed, in an insertion direction K toward an insertion opening 70B of the wrapping portion 7. The insertion opening 70B serves as the entry point for inserting the cable 19 into the rotation body 70 of the wrapping portion 7. The insertion direction K is the direction in which the cable 19 is inserted into the rotation body 70, and in the present embodiment is downward from the peeling portion 4 toward the wrapping portion 7. When the cable 19 is inserted, the rotation body 70 positions the insertion opening 70B at the upper portion.

The user moves the cable 19 downward in the insertion direction K along the second guide portions 21L and 21R toward the wrapping portion 7 located below the peeling portion 4. When passing between the second guide portions 21L and 21R and the pressing surface 61, the end portion of the label 160 is pressed against the cable 19 by the pressing surface 61.

The presser portion 25 is a plate-shaped member that presses the end portion of the label 160 against the cable 19. The presser portion 25 is arranged below the first convey guide 231, between the second guide portion 21L and the second guide portion 21R. A rear end portion of the presser portion 25 is rotatably supported by a shaft extending in the left-right direction. A tip end portion of the presser portion 25 is exposed between the second guide portions 21L and 21R and the pressing surface 61. The presser portion 25 is urged by a torsion spring so that the tip end portion is positioned above the rear end portion.

When the user moves the cable 19 downward along the second guide portions 21L and 21R, the presser portion 25 sandwiches the end portion of the label 160 between the tip end portion and the cable 19. The presser portion 25 is rotated by being pressed by the cable 19, thereby moving the tip end portion of the presser portion 25 downward. The presser portion 25 rotates while maintaining a state in which the end portion of the label 160 is pressed against the cable 19 so as to prevent the end portion of the label 160 from peeling off.

### Wrapping portion 7

The wrapping portion 7 affixes the label 160, one end of which is affixed to the cable 19 guided by the second guide portions 21L and 21R, by wrapping the label 160 around the cable 19. The wrapping portion 7 includes the approximately cylindrical rotation body 70 having a side surface that is partially missing. A rotational axis center 70A of the rotation body 70 extends in the left-right direction. The rotation body 70 is rotatably supported by a support 72 that is fixed to the left and right surfaces, respectively, of the base body 20. The rotation body 70 is rotationally driven by a wrapping motor.

The rotation body 70 houses arm portions 76 and 77 therein and supports the arm portions 76 and 77 so as to enable the arm portions 76 and 77 to swing. The arm portions 76 and 77 pinch and hold the cable 19 when the label 160 is wrapped around the cable 19. When the rotation body 70 rotates, the arm portions 76 and 77 rotate around the cable 19 and wrap the label 160 around the outer peripheral surface of the cable 19. The label 160 that has been wrapped around the outer peripheral surface of the cable 19 is affixed to the cable 19 by means of the adhesive 141.

### Winding portion 8

As shown in FIGS. 2 and 4, the winding portion 8 is positioned diagonally above and to the rear of the peeling portion 4. The winding portion 8 is arranged on the right surface of the main plate, above the front upper corner portion of the compartment 30. The winding portion 8 winds the release material 170 into a roll, thereby applying the tension necessary for feeding the tape 150 and peeling off the label 160.

As shown in FIG. 9, the winding portion 8 includes the reel 80 and a shaft 81. The reel 80 has a cylindrical shape, with the rotational axis center 80A extending in the left-right direction. The left surface of the reel 80 is closed and has an opening at the center through which the shaft 81 is inserted. The shaft 81 extends to the right from the right surface of the main plate, which is fixed to the housing 10. The shaft 81 is connected to a winding motor via a plurality of gears arranged in the drive unit on the right surface of the main plate.

The driving force of the winding motor is transmitted to the shaft 81 via the plurality of gears, thereby driving the reel 80 to rotate counterclockwise when viewed from the right. The length of the reel 80 in the left-right direction is greater than the maximum width of the tape 150 compatible with the label wrapping device 1. The right end portion of the reel 80 is open. The release material 170 is wound into a roll on an outer peripheral surface 80B of the reel 80. Upon disposal, the release material roll formed into a roll is pulled out to the right from the right end portion.

A slit-shaped slot 80F extending in the direction of the rotational axis center is formed in the outer peripheral surface 80B of the reel 80. An end portion of the release material 170 wound by the winding portion 8 is inserted into the slot 80F and is retained by a plate spring-shaped presser member 84 to prevent the release material 170 from being pulled out.

### Operation of label wrapping device 1

As shown in FIG. 4, in the label wrapping device 1, the tape 150 is pulled out from the tape cassette 100 in advance and is arranged along the first convey guide 231 and the second convey guide 236. The end portion of the tape 150 is inserted into the slot 80F of the reel 80 of the winding portion 8 and is held in place by the presser member 84.

During printing, the user operates an external terminal such as a PC to create print data for label printing, and transmits a print command to the label wrapping device 1. The control unit prints an image on the print surface Pt of the film tape 110, while conveying the tape 150 toward the cutting portion 9 by driving the convey motor. Furthermore, the control unit rotates the reel 80 by driving the winding motor to wind the release material 170. Note that when printing immediately after the tape 150 is held by the reel 80, because the label 160 has not yet separated from the release material 170, the tape 150 is wound onto the reel 80.

The label 160 on which the image has been printed is half-cut at the cutting portion 9 and then conveyed toward the peeling portion 4 in a separable state. The tension necessary for separating the label 160 is applied to the tape 150 by winding the release material 170 with the reel 80 of the winding portion 8.

While the tension is applied, the tape 150 is sharply bent at the peeling portion 4, causing the end portion of the label 160 on which the image has been printed to be peeled away from the release material 170. The driving of the winding motor and the convey motor is stopped. The end portion of the label 160 is arranged at the position spanning from the peeling portion 4 to the support surface 62 of the opening/closing portion 6, with the adhesive surface Ur1 facing upward.

The protrusions 65L and 65R cover, from the upstream in the insertion direction of the cable 19, a part of the end portion of the label 160 that is supported by the support surface 62. Therefore, the protrusions 65L and 65R inhibit the cable 19 from coming into contact with the end portion of the label 160 from the support surface 62. The user grips the cable 19, which extends in the left-right direction, with both hands and brings the cable 19 into contact with the first guide portions 16L and 16R. The user moves the cable 19 along the first guide portions 16L and 16R toward the end portion of the label 160 supported by the support surface 62.

The user affixes the end portion of the label 160 to the cable 19 at the peeling portion 4. The user moves the cable 19, to which the end portion of the label 160 has been affixed, downward along the second guide portions 21L and 21R, and inserts the cable 19 into the wrapping portion 7. Because the presser portion 25 presses the end portion of the label 160 against cable 19, detachment of the label 160 is suppressed. As the cable 19 moves downward, the portion of the label 160 that has not yet been separated is peeled from the release material 170. When a switch for detecting the cable 19 turns on, the rotation body 70 is rotated by the driving of the wrapping motor 79. The label 160 is wound around the outer peripheral surface of the cable 19 and is affixed to the cable 19 by the adhesive.

### Device configuration

In this manner, the label wrapping device 1 includes the winding portion 8 to wind the release material 170 peeled from the label 160. By providing the winding portion 8, the device configuration of the label wrapping device 1 becomes larger compared to a case where the winding portion 8 is not provided. In order to reduce the size, it is desirable to position the winding portion 8 closer to the peeling portion 4. Furthermore, in order to avoid interference with cable 19 during insertion when the winding portion 8 is positioned closer to the peeling portion 4, the layout of the device configuration in the label wrapping device 1 is defined as follows.

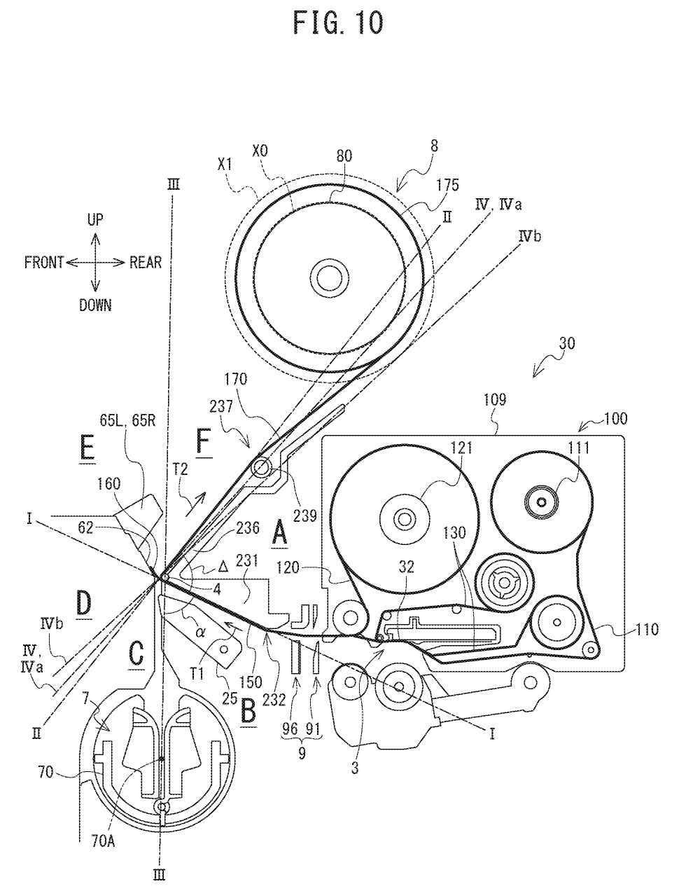

As shown in FIG. 10, when viewing the label wrapping device 1 from the side, for example, from the right, a line passing through the peeling portion 4 and extending in the first convey direction T1 is designated as virtual line I. In a right side view of the label wrapping device 1, a line passing through the peeling portion 4 and extending in the second convey direction T2 is designated as virtual line II. In a right side view of the label wrapping device 1, a line passing through the peeling portion 4 and the rotational axis center 70A of the rotation body 70 of the wrapping portion 7 is designated as virtual line III. Note that the side view refers to viewing the housing 10 as projected from the direction in which the rotational axis center 80A of the winding portion 8 extends. Because the rotational axis center 80A in the present embodiment extends in the left-right direction, a right side view refers to the case where the housing 10 is viewed projected from the right.

Moreover, of the areas sandwiched between the virtual line I and the virtual line II, the area toward the front is designated as area D, while the area toward the rear is designated as area A. Of the areas between the virtual line I and the virtual line III, the upper area is designated as area E, and the lower area is designated as area B. Of the areas between the virtual line II and the virtual line III, the upper area is area F, and the lower area is designated as area C.

### First to fourth conditions

The label wrapping device 1 satisfies first, second, third, and fourth conditions described below. The wrapping portion 7 is located in the areas B, C, and D among the areas separated by the virtual line I. In contrast, the winding portion 8 is located in the areas A, E, and F among the areas separated by the virtual line I, which are different from the area in which the wrapping portion 7 is located. This constitutes the first condition.

Next, as the second condition, the winding portion 8 does not intersect the virtual line III. That is, the winding portion 8 is not arranged across both the area E and the area F straddling the virtual line III, but instead is positioned to the rear of the virtual line III.

Next, the compartment 30 is located in the areas A, B, and F among the areas separated by the virtual line III. In contrast, the winding portion 8 is located in the same areas as the compartment 30, that is, in the areas A, B, and F among the areas separated by the virtual line III. This constitutes the third condition.

Next, the wrapping portion 7 is located in the areas A, B, and C among the areas separated by the virtual line II. In contrast, the compartment 30 is located in the same area as the compartment 30, that is, in the areas A, B, and C among the areas separated by the virtual line II. This constitutes the fourth condition.

Accordingly, to satisfy the first to fourth conditions, the winding portion 8 is located in the areas A and F, the compartment 30 is located in the areas A and B, and the wrapping portion 7 is located in the areas B and C.

### Fifth condition

The label wrapping device 1 may use an outwardly wound tape in which the tape 150 pulled out from the tape cassette 100 is wound with the label 160 arranged to the outside of the release material 170. In this case, in addition to the above-described first to fourth conditions, the layout of the device configuration of the label wrapping device 1 satisfies the fifth condition described below.

In the case of an outwardly wound tape, the compartment 30 is located in the area sandwiched between the virtual line I and the virtual line II, that is, in the areas A and D. This constitutes the fifth condition.

Note that the tape 150 of the present embodiment is formed by laminating the film tape 110 and the double-sided adhesive tape 120. When the tape 150 is pulled out, the double-sided adhesive tape 120 is affixed to the inner surface of the film tape 110 when the film tape 110 was wound clockwise onto the spool 111. The base material 140 of the double-sided adhesive tape 120 and the release material 170 are made of paper and therefore are less rigid than the film tape 110 made of PET, for example. Accordingly, when the tape 150 is pulled out from the tape cassette 100, the tape 150 has a curl similar to that of an outwardly wound tape wound with the label 160 arranged to the outside of the release material 170. Accordingly, the tape 150 can be regarded as an outwardly wound tape.

Accordingly, the compartment 30 is in the area that satisfies the first to fifth conditions, that is, in area A.

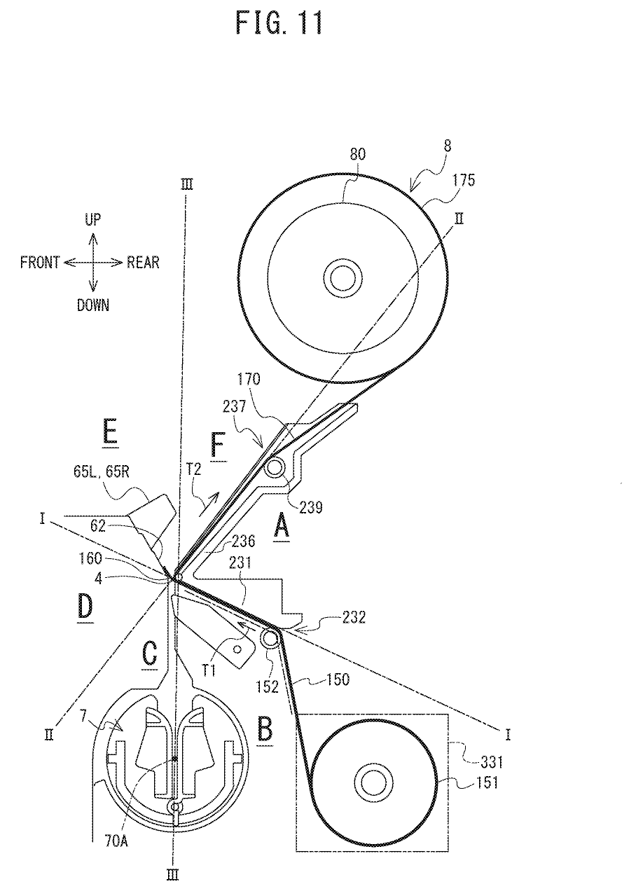

As shown in FIG. 11, a case will be considered in which there is no fifth condition, and, in accordance with the first to fourth conditions, a roll 151 with the tape 150 wound outwardly is arranged in the area B. For the sake of convenience in explanation, the roll 151 is taken as an example of the outwardly wound tape. The tape 150 pulled out from the outwardly wound roll 151 must be wound clockwise, in a right side view, in order for the label 160 to be arranged to the outside of the release material 170 at the peeling portion 4. The area B is located below the virtual line I. Therefore, when the roll 151 that is outwardly wound in the clockwise direction is arranged in the area B, in order to guide the tape 150 along the first convey direction T1, it becomes necessary to change the convey direction of the tape 150 by arranging, for example, a roller member 152 at the bend portion 232. In this case, the tape 150 is guided so that the release material 170 is to the outside of the label 160 by using the roller member 152, such that the tape 150 is bent in the direction opposite the direction in which the tape 150 curls, and is conveyed in a direction along the first convey direction T1.

However, if the tape 150 is bent in the direction opposite the curling direction upstream of the peeling portion 4 in the convey direction, there is a possibility that the label 160 may peel off. Therefore, it is preferable that a compartment 331 of the outwardly wound roll 151 is located in the area A, which satisfies the first to fifth conditions.

### Sixth condition

Incidentally, a case will be considered in which, within the case 109 of the tape cassette 100, the film tape 110 is wound counterclockwise onto the spool 111. In this case, when the tape 150 is pulled out from the tape cassette 100, the tape 150 has a curl similar to that of an inwardly wound tape wound with the label 160 arranged to the inside of the release material 170. If the tape 150 is an inwardly wound tape, the layout of the device configuration of the label wrapping device 1 satisfies the following sixth condition in addition to the above-described first to fourth conditions.

In the case of an inwardly wound tape, the compartment 30 is located in the same areas as the wrapping portion 7, that is, in the areas B, C, and D among the areas separated by the virtual line I. This constitutes the sixth condition. Accordingly, the compartment 30 is located in the area that can simultaneously satisfy the first to fourth conditions and the sixth condition, that is, the area B.

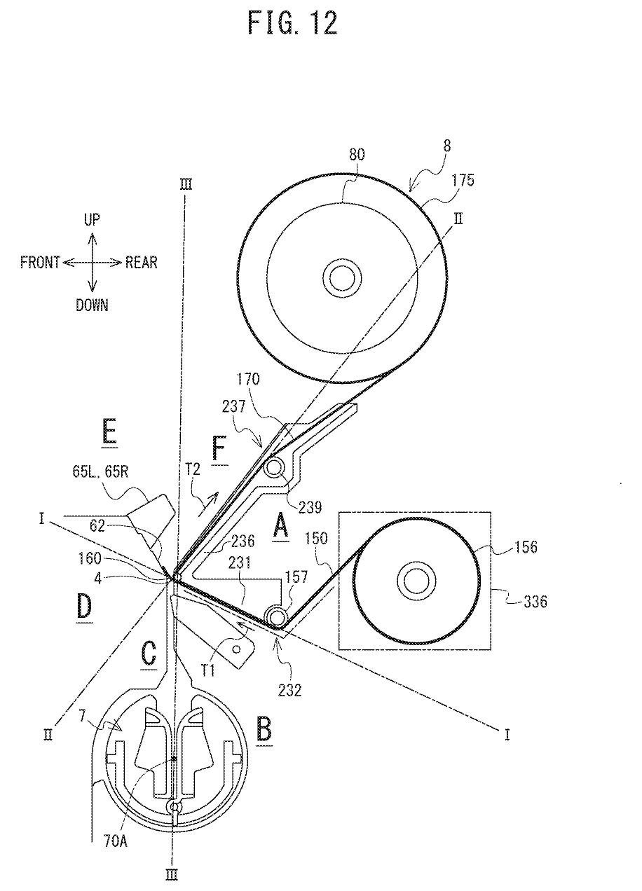

As shown in FIG. 12, a case will be considered in which there is no sixth condition, and, in accordance with the first to fourth conditions, a roll 156 in which the tape 150 is wound inwardly is arranged in the area A. For the sake of convenience in explanation, the roll 156 is taken as an example of the inwardly wound tape. The tape 150 pulled out from the inwardly wound roll 156 must be wound counterclockwise in a right side view, in order for the label 160 to be positioned to the outside the release material 170 at the peeling portion 4. The area A is located above the virtual line I. Therefore, when a tape that is inwardly wound in the counterclockwise direction is arranged in the area A, in order to guide tape 150 along the first convey direction T1, it becomes necessary to change the convey direction of the tape 150 by arranging, for example, a roller member 157 at the bend portion 232. In this case, the tape 150 is guided by the roller member 157 such that the tape 150 is bent in the direction opposite the direction in which the tape 150 curls, and is conveyed in the direction along the first convey direction T1.

When the tape 150 is bent by the roller member 157, it is bent with the label 160 positioned outside relative to the release material 170. However, if the tape 150 is bent in the direction opposite to the curling direction induced by the roller member 157, and moreover the label 160 is bent outward beyond the release material 170, there is a possibility that the label 160 may peel off. Therefore, it is preferable that the compartment 336 for the inwardly wound tape be located within the area B, which satisfies the first to fourth and the sixth conditions.

### Seventh condition

When the positional relationship between the winding portion 8 and the compartment 30 is further considered, the label wrapping device 1 satisfies the following seventh condition. The winding portion 8 is located, within the area sandwiched between the virtual line I and the virtual line III, in an area different from the area in which the compartment 30 is located. The this constitutes the seventh condition.

Based on the first to fourth conditions, the winding portion 8 is positioned in the areas A and F. According to the first to fifth conditions, the compartment 30 is positioned in the area A. On the other hand, according to the first to fourth conditions and the sixth condition, the compartment 30 is positioned in the area B. Accordingly, in the case where the tape 150 is an outwardly wound tape, the winding portion 8 is located in an area that simultaneously satisfies the first to fifth conditions and the seventh condition, that is, in the area F. Further, in the case where the tape 150 is a tape wound in the inside direction, the winding portion 8 is located in the areas where the first to fourth conditions, the sixth condition, and the seventh condition can be simultaneously satisfied, specifically, in the areas A and F.

### Eighth and ninth conditions

In order to enlarge the winding portion 8 or bring it closer to the peeling portion 4, it is effective to increase the angle formed between the virtual line II and the virtual line III so as to expand the area F. Here, to ensure that the label 160 is reliably separated at the peeling portion 4, it is necessary to secure the label peel angle Δ. Accordingly, if the angle formed between the virtual line I and the virtual line III is designated as α, by decreasing the angle α while maintaining the peeling angle Δ, the angle formed between the virtual line II and the virtual line III can be widened. Note that in the case where the tape 150 is wound outward, the eighth and ninth conditions will be considered.

According to the first to fifth conditions, the compartment 30 is located within the area A. The winding portion 8 is located in an area separated by the virtual line II, which is different from the area in which the compartment 30 is located, that is, in the area F. This constitutes the eighth condition.

Next, the angle α formed between the virtual line I and the virtual line III satisfies 0° < α < 90°. Note that the angle α is the angle formed between the virtual line I and the virtual line III within the area B. In order to increase the angle formed by the virtual line II and the virtual line III while maintaining the peeling angle Δ, it is preferable for the angle α to be an acute angle and as small as possible. This constitutes the ninth condition.

By appropriately combining and applying the aforementioned first to ninth conditions, the label wrapping device 1 can avoid interference with the winding portion 8 during cable 19 insertion while simultaneously achieving a reduction in the size of the device configuration.

### Function and effects

As described above, since the label wrapping device 1 includes the winding portion 8, it can wind the release material 170 from which the label 160 has been peeled off. Furthermore, the positional relationship among the winding portion 8, the wrapping portion 7, and the compartment 30 is defined by the first to fourth conditions using the virtual lines I, II, and III. That is, the winding portion 8 is arranged in the area A and the area F, the compartment 30 is arranged in the area A and the area B, and the wrapping portion 7 is arranged in the area B and the area C. By satisfying the first to fourth conditions, the device configuration of the label wrapping device 1 can be made smaller.

The winding portion 8, which winds the release material 170, does not intersect the virtual line III. Therefore, when the cable 19 is moved along the first guide portions 16L and 16R, the cable 19 does not come into contact with the winding portion 8. Accordingly, the label wrapping device 1 is able to ensure a structure in which the cable 19 can be easily inserted into the insertion opening 70B of the wrapping portion 7.

When the tape 150 is an outwardly wound tape, the label wrapping device 1 defines the device configuration not only in accordance with the first to fourth conditions but also based on the fifth condition. In other words, the compartment 30 is arranged in the area A. Therefore, the label wrapping device 1 is able to draw out and convey the outwardly wound label 160 without bending the tape 150 in the direction opposite the curling direction of the tape 150.

When the tape 150 is an inwardly wound tape, the label wrapping device 1 defines the device configuration according to the sixth condition in addition to the first to fourth conditions. That is, the compartment 30 is positioned within the area B. Therefore, the label wrapping device 1 is able to draw out and convey the inwardly wound label 160 without bending the tape 150 in the direction opposite to the curling direction of the tape 150.

With regard to the positional relationship between the winding portion 8 and the compartment 30, the label wrapping device 1 defines the device configuration in accordance with the first to fourth conditions, either the fifth condition or the sixth condition, and further, the seventh condition. That is, when the tape 150 is an outwardly wound tape, the winding portion 8 is arranged in the area F. When the tape 150 is an inwardly wound tape, the winding portion 8 is arranged in the areas A and F. As a result, the device configuration of the label wrapping device 1 can be made smaller.

In order to enlarge the winding portion 8 or to bring the winding portion 8 closer to the peeling portion 4, the label wrapping device 1 defines its device configuration in accordance with the first to fifth conditions, as well as the eighth and ninth conditions. That is, the winding portion 8 is arranged in the area F. In addition, the angle α formed by the virtual line I and the virtual line III is defined as 0° < α < 90°. Then, the first convey direction T1 is inclined further in the vertical direction so that the angle α becomes smaller, and the second convey direction T2 is inclined further in the horizontal direction without changing the peeling angle Δ. As a result, the angle formed by the virtual lines II and III is widened, thereby ensuring greater flexibility in determining the position and size of the winding portion 8 arranged in the area F. Thus, the label wrapping device 1 can increase the size of the winding portion 8 while ensuring ease of insertion of the cable 19.

The second convey guide 236 extends in the second convey direction T2, and changes the convey direction at the bend portion 237 to extend in the third convey direction T3. By changing the convey direction of the release material 170 downstream of the peeling portion 4, the label wrapping device 1 can expand the area in which the winding portion 8 is arranged without changing the peeling angle Δ. Therefore, with the label wrapping device 1, the size of the winding portion 8 can be increased while ensuring ease of insertion of the cable 19.

The roller member 239 at the bend portion 237 of the second convey guide 236 protrudes toward the reel 80 with respect to the virtual line IV. Accordingly, in the state X0 at the start of winding when the winding portion 8 starts to wind the release material 170, the roller member 239 protrudes closer to the reel 80 than the virtual line IVa. Furthermore, even in the state X1 at the end of winding of the release material 170, the roller member 239 protrudes toward the reel 80 with respect to the virtual line IVb. Accordingly, the release material 170 is wound onto the reel 80 via the roller member 239 both at the start and at the end of winding of the release material 170. Accordingly, the peeling angle Δ of the release material 170 does not change, so the peeling of the label 160 in the label wrapping device 1 is stable.

The rotatable roller member 239 is arranged at the bend portion 237. Because the convey load at the bend portion 237 can be reduced by the roller member 239, the label wrapping device 1 is able to prevent breakage of the release material 170.

The label wrapping device 1 includes the half-cut cutting blade 96. Accordingly, the label wrapping device 1 can not only wrap pre-cut die-cut labels of a predetermined size, but can also cut the label 160 of an indefinite length to any desired length and wrap the label 160 onto the cable 19.

In the convey path R1, the convey direction is changed at the bend portion 232 located downstream of the half-cut cutting blade 96. Therefore, the label wrapping device 1 does not need to arrange the half-cut cutting blade 96 within the housing 10 in an orientation aligned with the first convey direction T1. Therefore, interference between the half-cut cutting blade 96 and the wrapping portion 7 can be avoided, enabling the device configuration of the label wrapping device 1 to be made smaller.

The tape 150 is produced by laminating the film tape 110 with the double-sided adhesive tape 120 housed in the case 109 of the tape cassette 100. Because the label wrapping device 1 allows the case 109 in which the tape 150 is housed in advance to be installed in the compartment 30, handling of the tape 150 can be facilitated.

The print mechanism 3 is arranged upstream of the half-cut cutting blade 96. Therefore, the label wrapping device 1 is capable of printing on the label 160. Accordingly, the label wrapping device 1 can wrap not only pre-printed labels 160 but also labels 160 on which desired printing has been performed, around the cable 19.

The label wrapping device 1 includes the full-cut cutting blade 91 that cuts the tape 150, which is arranged between the print mechanism 3 and the half-cut cutting blade 96. Accordingly, because the label wrapping device 1 is capable of fully cutting the tape 150, the tape cassette 100 can be easily replaced.

The peeling portion 4 is a roller that is rotatably supported. Therefore, because the label wrapping device 1 can reduce the convey load at the peeling portion 4 by the roller, the risk of breakage of the release material 170 can be reduced.

### Others

In the above-described embodiment, the cable 19 is one example of the bar-shaped member of the present disclosure. The tape 150 is one example of the medium of the present disclosure. The film tape 110 and double-sided adhesive tape 120 wound on the spools 111 and 121 prior to being adhered together as the tape 150 are examples of the medium roll of the present disclosure. The rotation body 70 is one example of the rotational member of the present disclosure.

The virtual lines I, II, and III are respective examples of the first virtual line, the second virtual line, and the third virtual line of the present disclosure. The second convey guide 236 is one example of the winding guide of the present disclosure. The bend portion 237 is one example of the first bend portion of the present disclosure. The virtual line IV is one example of the fourth virtual line of the present disclosure. The half-cut cutting blade 96 is one example of the half-cut portion of the present disclosure.

The first convey guide 231 is one example of the convey guide of the present disclosure. The bend portion 232 is one example of the second bend portion of the present disclosure. The case 109 is one example of the cassette case of the present disclosure. The thermal head 32 and the platen roller 33 are examples of the print portion of the present disclosure. The full-cut cutting blade 91 is one example of the full-cut portion of the present disclosure.

### Modified examples

The present disclosure is not limited to the above-described embodiment; various modifications are possible. The printing method employed by the print mechanism 3 is not limited to the above-described embodiment. For example, the label wrapping device 1 may perform printing using a receptor-type tape cassette. The receptacle-type tape cassette houses a tape, in which a base material and a release material that is adhered to an adhesive surface of the base material to which an adhesive has been applied are laminated together, as well as an ink ribbon. The print mechanism 3 performs printing on the surface of the tape opposite to the adhesive surface.

The label wrapping device 1 need not required to include the print mechanism 3. In this case, the label wrapping device 1 may half-cut a label, on which an image has been printed in advance, to a predetermined or desired length, peel the label from the release material, and wrap and affix the label onto the cable 19. Further, the printing on the tape 150 may be performed by an external printing device. The label wrapping device 1 may also be a printing device that prints on labels without the wrapping portion 7 provided.

The label wrapping device 1 need not required to include the full-cut cutting blade 91. When replacing the tape cassette 100, the user may cut the tape 150 using scissors, for example. Additionally, the full-cut cutting blade 91 may cut the tape 150 with the driving force from the drive motor. The label wrapping device 1 need not required to include the half-cut cutting blade 96. In this case, it is also permissible to use, as the medium, a tape to which a label die-cut in advance is adhered to the release material.

The object to which label 160 is affixed is not limited to the cable 19, and may also be another bar-shaped member or adherend. For example, the label 160 may be affixed to stationery such as pens or to tools such as screwdrivers. Furthermore, the adhesive surface of the tape 150 is not limited to one with the applied adhesive 141, adhesiveness may also be obtained by processing.

The tape 150 need not necessarily be housed in the case 109 of the tape cassette 100. In this case, it is sufficient to install a tape roll, in which tape 150 is wound into a roll, in the compartment 30. In that case, the compartment 30 is a portion for rotatably installing and housing the tape roll, and it is only necessary to include a peripheral wall or a shaft for supporting the tape roll.

Further, the tape 150 may be a thermal label to which an adhesive has been previously applied and a release material is attached. Note that the thermal label is a label in the form of an indefinite-length tape. The thermal label may be wound and installed in the compartment 30 without being accommodated in the case 109. Of course, the thermal label in a wound state may be accommodated in the case 109. The print mechanism 3 may perform printing on the thermal label by applying heat to the thermal label to induce color development.

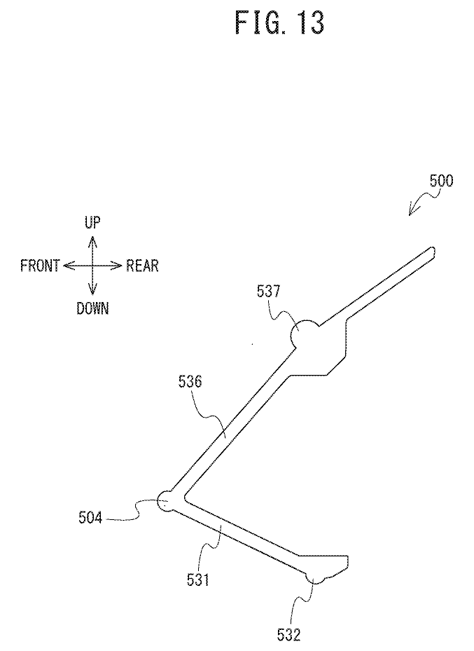

As shown in FIG. 13, a peeling portion 504 may protrude at a connection portion between a first convey guide 531 and a second convey guide 536, and may have a shape that extends in the left-right direction with a semicircular cross-portion. Further, instead of the first convey guide 231 and the second convey guide 236, it is also possible to use a convey member 500 in which the first convey guide 531 and the second convey guide 536 are integrally formed. Furthermore, protrusions having a semicircular cross-portion and extending in the left-right direction may be provided at bend portions 532 and 537 as well.

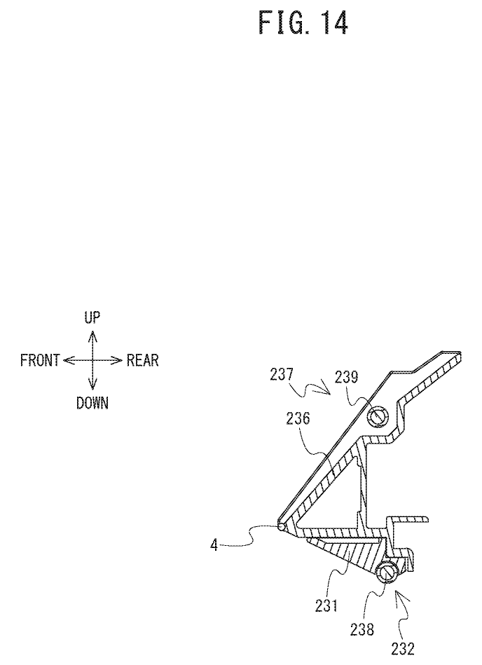

As shown in FIG. 14, a roller member 238 may also be arranged at the bend portion 232 of the first convey guide 231 in the same manner as at the bend portion 237. The roller member 238 has a round bar shape extending in the left-right direction and is rotatably supported on a shaft below the first convey guide 231. The roller member 238 protrudes downward from the first convey guide 231 at the bend portion 232. In this case, the convey load at the bend portion 232 can be reduced by the roller member 238, so the label wrapping device 1 can reduce the risk of breakage of the tape 150. Note that, in this modified example, the roller member 238 is one example of the roller of the present disclosure.

It is not necessary to provide a portion of the first convey guide 231 upstream of the bend portion 232. It is not necessary to provide a portion of the second convey guide 236 downstream of the bend portion 237.

What is claimed is:

1. A label wrapping device configured to wrap a label around a bar-shaped member, comprising:
a compartment configured to receive a medium including a label and an adhesive medium formed by an adhesive material and a release material by adhering together;
a winding portion configured to rotate about a rotation shaft, and convey and wind the release material of the medium formed by adhering the label and the adhesive material together and pulled out from the compartment while applying tension to the release material;
a peeling portion configured to contact the release material of the medium conveyed from the compartment to the winding portion, change a convey direction of the release material from a first convey direction to a second convey direction, and peel an end portion of the label from the release material;
a wrapping portion including a rotation member having an insertion opening and configured to rotate around and support the bar-shaped member inserted through the insertion opening, and wrap the label around the bar-shaped member;
a first guide portion configured to guide the bar-shaped member toward the label that has been peeled from the release material by the peeling portion; and
a second guide portion configured to guide the bar-shaped member, with the label affixed after being guided by the first guide portion and peeled off by the peeling portion, toward the insertion opening,
wherein
at least a portion of the peeling portion is arranged in an insertion path of the bar-shaped member defined by the first guide portion and the second guide portion,
when projected from a direction along an extension of the rotation shaft,
a line passing through the peeling portion and extending in the first convey direction is designated as a first virtual line,
a line passing through the peeling portion and extending in the second convey direction is designated as a second virtual line,
a line passing through the peeling portion and a rotation center of the rotation member of the wrapping portion is designated as a third virtual line,
the winding portion
is arranged in an area different from an area where the wrapping portion is arranged with respect to the first virtual line, and
is arranged in a same area as the compartment is arranged with respect to the third virtual line and does not intersect the third virtual line, and
the compartment
is arranged in a same area as the wrapping portion is arranged with respect to the second virtual line.

2. The label wrapping device according to claim 1, wherein
the medium is installed in a roll form by winding the medium with the label arranged on the outside of the release material, and
the compartment is arranged in an area sandwiched by the first virtual line and the second virtual line when projected from the direction along an extension of the rotation shaft.

3. The label wrapping device according to claim 1, wherein
the medium is installed in a roll form by winding the medium with the label arranged to an inside of the release material, and
the compartment is arranged in a same area as the wrapping portion, among the areas separated by the first virtual line, when projected from the direction along an extension of the rotation shaft.

4. The label wrapping device according to claim 2, wherein
the winding portion is arranged in an area different from an area where the compartment is arranged, among areas sandwiched by the first virtual line and the third virtual line, when projected from the direction along an extension of the rotation shaft.

5. The label wrapping device according to claim 1, wherein
when projected from the direction along an extension of the rotation shaft, the winding portion is arranged in one of the areas separated by the second virtual line, the area is different from an area where the compartment is arranged, and
when the winding portion is arranged within an area separated by the third virtual line, and another area located between the first virtual line and the third virtual line does not include the winding portion, an angle α formed by the first virtual line and the third virtual line satisfies a condition: 0°< α < 90°.

6. The label wrapping device according to claim 5, further comprising:
a winding guide configured to guide the release material from the peeling portion toward the winding portion,
wherein
the winding guide includes a first bend portion, the first bend portion is configured to contact the release material and change the convey direction of the release material from the second convey direction to a third convey direction,
a portion of the winding guide located upstream of the first bend portion extends in the second convey direction, and
a portion of the winding guide located downstream of the first bend portion extends in the third convey direction, in the third convey direction, an intersection angle with the first convey direction is smaller than the intersection angle between the first convey direction and the second convey direction.

7. The label wrapping device according to claim 6, wherein
the winding portion is a reel, and
the first bend portion protrudes toward the reel with respect to a fourth virtual line contacting the reel from the peeling portion.

8. The label wrapping device according to claim 7, wherein
a roller rotatably held is arranged at the first bend portion.

9. The label wrapping device according to claim 6, further comprising:
a half-cut portion configured to cut the label without cutting the release material, and arranged between the compartment and the peeling portion, when projected from the direction along an extension of the third virtual line.

10. The label wrapping device according to claim 9, further comprising:
a convey guide configured to guide the medium from the compartment toward the peeling portion,
wherein
the convey guide is arranged with a convey path for the medium positioned downstream of the half-cut portion, the convey guide includes a second bend portion, the second bend portion is configured to contact the release material and change the convey direction of the release material, a portion of the convey guide located downstream of the second bend portion extends in the first convey direction.

11. The label wrapping device according to claim 10, wherein
a roller rotatably held is arranged at the second bend portion.

12. The label wrapping device according to claim 1, wherein
the medium is included in a cassette case in a roll form by winding each of the label and the adhesive material, and
the cassette case is installed in the compartment.

13. The label wrapping device according to claim 1, wherein
the medium is included in a cassette case in a roll form by adhering the label and the adhesive material together, and
the cassette case is installed in the compartment.

14. The label wrapping device according to claim 9, wherein
a print portion is arranged between the compartment and the half-cut portion when projected from the direction along an extension of the third virtual line.

15. The label wrapping device according to claim 14, further comprising:
a full-cut portion configured to cut the medium, and arranged between the print portion and the half-cut portion, when projected from the direction along an extension of the third virtual line.

16. The label wrapping device according to claim 1, wherein
the peeling portion is a roller rotatably held.
